(19) United States
(12) Patent Application Publication
(10) Pub. No.: US 2026/0313078 A1
(43) Pub. Date: Oct. 8, 2026

(54) IMAGE CORRECTION METHOD

(71) Applicant: SEIKO EPSON CORPORATION, Tokyo (JP)

(72) Inventor: Takumi ARAGAKI, Shiojiri-shi (JP)

(21) Appl. No.: 19/640,478

(22) Filed: Apr. 7, 2026

(30) Foreign Application Priority Data
Apr. 8, 2025 (JP) 2025-063678

(51) Int. Cl. H04N 9/31; H04N 9/67

(52) U.S. Cl. CPC H04N 9/3182; H04N 9/3194; H04N 9/67

(57) ABSTRACT

The correction method includes executing color correction using an R color correction gain, a G color correction gain, and a B color correction gain when at least one of the color correction gains is smaller than a maximum threshold, and executing the color correction using the R color correction gain, the G color correction gain, and the B color correction gain when the color correction gains are all greater than a minimum threshold.

### CROSS REFERENCE TO RELATED APPLICATIONS

The present application is based on, and claims priority from JP Application Serial Number 2025-063678, filed Apr. 8, 2025, the disclosure of which is hereby incorporated by reference herein in its entirety.

### BACKGROUND

### 1. Technical Field

The present disclosure relates to a method for correcting an image projected by a projector.

### 2. Related Art

In related art, a dedicated screen (for example, white screen) installed in a dark room is used in most cases for projection performed by a projector. However, as a result of size reduction, cost reduction, transition to higher luminance, and other changes in a projector, there is an increasing need for projection onto a projection receiving surface such as a wall of an office or a living room.

In such a case, the projection receiving surface rarely has a uniform, high reflectance, and there is a problem of significant deviation between an original image to be projected and an image as a result of projection due to the influence of the color, brightness, and other factors of the ambient light.

To solve such a problem, there has been a proposed color correction technology for correcting the color of an image input to the projector based on a relationship determined in advance between the input image and an image displayed on a projection receiving surface and captured by a camera to reduce the deviation. The color correction technology of this type is disclosed, for example, in JP-A-2007-322671.

JP-A-2007-322671 is an example of the related art.

A projection target image, however, needs to be corrected in terms of color when an appropriate condition is satisfied. This is because correcting the color of the projection target image when the appropriate condition is not satisfied due to various factors causes deterioration of the result of the color correction on the contrary.

### SUMMARY

An image correction method according to an aspect of the present disclosure includes: sequentially projecting, via a projector including a light modulating element having multiple first pixels, multiple pattern images onto a projection receiving surface, the multiple pattern images projected via the multiple first pixels having pixel values different from each other; acquiring multiple captured images corresponding on a one-to-one basis to the multiple pattern images by sequentially capturing, with a camera including an imaging element having multiple second pixels, images of the projection receiving surface onto which the multiple pattern images are sequentially projected; generating a color conversion matrix used to convert pixel values of the multiple second pixels into pixel values of the multiple first pixels based on the multiple captured images; calculating, based on the pixel values of the multiple second pixels and the color conversion matrix, color correction gains to be applied to the pixel values of the multiple first pixels to bring colors of the images of the projection receiving surface captured by the camera close to target colors; and

executing color correction using the color correction gain for R, the color correction gain for G, and the color correction gain for B when at least one of the color correction gains is smaller than a maximum threshold.

An image correction method according to another aspect of the present disclosure includes sequentially projecting, via a projector including a light modulating element having multiple first pixels, multiple pattern images onto a projection receiving surface, the multiple pattern images projected via the multiple first pixels having pixel values different from each other; acquiring multiple captured images corresponding on a one-to-one basis to the multiple pattern images by sequentially capturing, with a camera including an imaging element having multiple second pixels, images of the projection receiving surface onto which the multiple pattern images are sequentially projected; generating a color conversion matrix used to convert pixel values of the multiple second pixels into pixel values of the multiple first pixels based on the multiple captured images; calculating, based on the pixel values of the multiple second pixels and the color conversion matrix, color correction gains to be applied to the pixel values of the multiple first pixels to bring colors of the images of the projection receiving surface captured by the camera close to target colors; and

executing color correction using the color correction gain for R, the color correction gain for G, and the color correction gain for B when the color correction gains are all greater than a minimum threshold.

### BRIEF DESCRIPTION OF THE DRAWINGS

FIG. 1 is a block diagram of a projection display apparatus used in a correction method according to an embodiment.

FIG. 2 is a flowchart showing the procedure of the correction method.

FIG. 3 shows an example of R, G, B, and K patterns used in the correction method.

FIG. 4 shows an example of an averaged captured image produced in an ideal projection environment in the correction method.

FIG. 5 shows an example of a degamma-processed captured image produced in the ideal projection environment in the correction method.

FIG. 6 shows an example of a color output characteristic produced in the ideal projection environment in the correction method.

FIG. 7 shows an example of target white values in the correction method.

FIG. 8 shows an example of an averaged captured image produced in an actual projection environment in the correction method.

FIG. 9 shows an example of a degamma-processed captured image produced in the actual projection environment in the correction method.

FIG. 10 shows an example of a color output characteristic produced in the actual projection environment in the correction method.

FIG. 11 illustrates color correction executed by a color correction portion in the correction method.

FIG. 12 shows a method for calculating color correction gains in the correction method.

FIG. 13 shows the method for calculating color correction gains in the correction method.

### DESCRIPTION OF EMBODIMENTS

A preferred embodiment according to the present disclosure will be described below with reference to the accompanying drawings. Note in the drawings that the dimensions and scale of each portion differ from the actual values as appropriate and some portions are diagrammatically shown to facilitate understanding thereof. The scope of the present disclosure is not limited to the embodiment unless there is a description that particularly limits the present disclosure in the following description.

### 1. Embodiment

### 1-1. Overview of projection display apparatus used in correction method

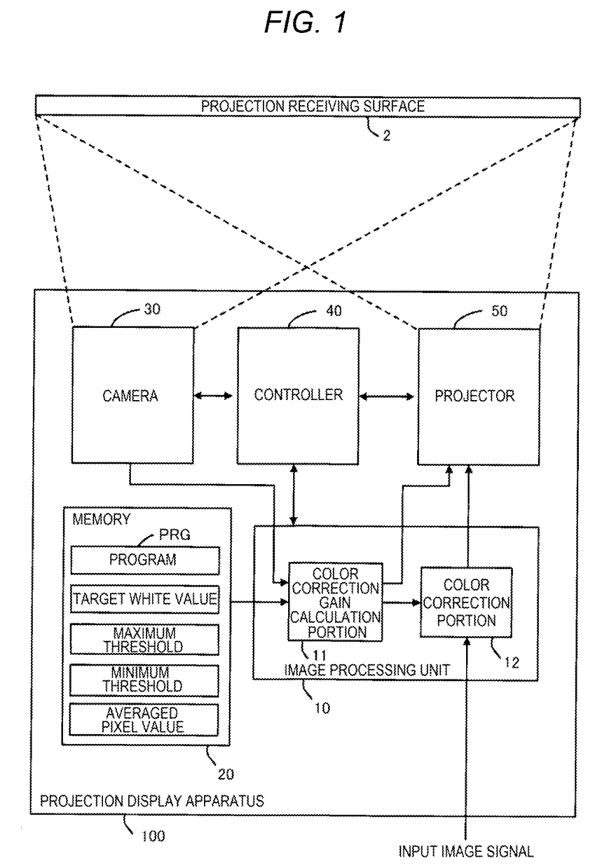

FIG. 1 is a block diagram of a projection display apparatus 100 used in a correction method according to an embodiment. The projection display apparatus 100 includes an image processing unit 10, a memory 20, a camera 30, a controller 40, and a projector 50, as shown in FIG. 1.

The projector 50 is a unit that includes an optical system such as light modulating elements each having multiple first pixels, and projects an image onto a projection receiving surface 2 via the optical system. The projector 50 includes, for example, a light source, a light modulator, and a lens. The light source includes a halogen lamp, a xenon lamp, an ultrahigh-pressure mercury lamp, a light emitting diode (LED), or a laser light source, and outputs red light, green light, and blue light. The optical modulator includes, for example, three light modulating elements provided in correspondence with R, G, and B. The light modulating elements each include, for example, a transmissive liquid crystal panel, a reflective liquid crystal panel, or a digital mirror device (DMD) and modulate light having a corresponding color to generate image light of the color. The multiple types of color image light generated by the light modulator are combined with one another by a light combining system into full-color image light. In the present embodiment, the projector 50 projects an image provided via the image processing unit 10 onto the projection receiving surface 2.

The camera 30 is a unit that includes an imaging element having multiple second pixels and captures, via the imaging element, an image of the image projected onto the projection receiving surface 2.

The controller 40 is a unit that controls the camera 30, the projector 50, and the image processing unit 10, and includes a processor, for example, a central processing unit (CPU).

The image processing unit 10 is a computer including a processor such as a CPU, as the controller 40 is. The image processing unit 10 may be configured with a single processor or multiple processors. Some or all of the functions of the image processing unit 10 may be realized by hardware such as a digital signal processor (DSP), an application-specific integrated circuit (ASIC), a programmable logic device (PLD), or a field programmable gate array (FPGA). The image processing unit 10 may be integrated with the controller 40.

The memory 20 includes a volatile storage such as a RAM and a nonvolatile storage such as a ROM or an HD. The volatile storage is used as a work area by the controller 40 and the image processing unit 10. The nonvolatile storage stores various programs to be executed by the controller 40 and the image processing unit 10.

FIG. 1 shows a program PRG stored in the memory 20. The image processing unit 10, which is a computer, executes the program PRG to function as a color correction gain calculation portion 11 and a color correction portion 12. FIG. 1 further shows data on target white values, a maximum threshold, a minimum threshold, and averaged pixel values used or generated by the image processing unit 10. Detailed contents of the data will be clarified in the description of the operation in the present embodiment.

The color correction portion 12 is a unit that multiplies pixel value of an externally input image signal by color correction gains to correct the colors of an image input to the projector 50. The color correction gains are gains by which the image signal is multiplied to make colors observed at any projection receiving surface 2 (such as wall) when the image signal is projected by the projector 50 onto the projection receiving surface 2 (such as wall) equal to colors observed at a projection receiving surface 2 (white screen) as a result of projection under an ideal environment (white screen, dark room).

The color correction gain calculation portion 11 is a unit that calculates the color correction gains to be provided to the color correction portion 12 and switches a state in which the color correction is executed to a state in which the color correction is not executed and vice versa.

In the present embodiment, the color correction gain calculation portion 11 causes the projector 50, which includes the light modulating elements each having the multiple first pixels, to sequentially project multiple pattern images having different pixel values of the multiple first pixels onto the projection receiving surface 2. Furthermore, the color correction gain calculation portion 11 causes the camera 30, which includes an imaging element having the multiple second pixels, to sequentially capture images of the multiple pattern images sequentially projected onto the projection receiving surface 2 to acquire multiple captured images corresponding to the multiple pattern images on a one-to-one basis.

The color correction gain calculation portion 11 calculates a color conversion matrix used to convert the pixel values of the multiple second pixels into the pixel values of the multiple first pixels based on the multiple captured images. The color correction gain calculation portion 11 then calculates color correction gains to be applied to the pixel values of the multiple first pixels to bring the colors of the images displayed at the projection receiving surface 2 and captured by the camera 30 close to target colors based on the pixel values of the multiple second pixels and the color conversion matrix.

In a preferred aspect, the color correction gain calculation portion 11 acquires at least a color output characteristic in an actual projection environment under which projection onto any projection receiving surface 2 such as a wall is performed in any room. The color output characteristic is a matrix used to convert the pixel values of the multiple first pixels into the pixel values of the multiple second pixels. The color correction gain calculation portion 11 calculates the color conversion matrix based on the color output characteristic. Specifically, the inverse matrix of the color output characteristic is used as the color conversion matrix. The color correction gain calculation portion 11 then calculates the color correction gains based on the target white values provided from the color output characteristic in the ideal projection environment, in which projection onto the projection receiving surface 2, which is a white screen, is performed in a dark room; the pixel values for display in black provided from the color output characteristic under the actual projection environment; and the color conversion matrix. Note that the color correction gain calculation portion 11 may acquire the color output characteristic under the ideal projection environment through measurement, externally, or in any other manner.

When at least one of an R (Red) correction gain, a G (Green) correction gain, and a B (Blue) correction gain is smaller than a maximum threshold Th_max, the color correction gain calculation portion 11 causes the color correction portion 12 to execute the color correction, but otherwise does not cause the color correction portion 12 to execute the color correction.

When the R correction gain, the G correction gain, and the B correction gain are each greater than a minimum threshold Th_min, the color correction gain calculation portion 11 causes the color correction portion 12 to execute the color correction, but otherwise does not cause the color correction portion 12 to execute the color correction.

At the time of projection in the actual projection environment, the color correction portion 12 corrects the pixel values of the input image signal by using the color correction gains calculated by using the color correction gain calculation portion 11, and supplies the corrected pixel values to the projector 50.

### 1-2. Image correction method

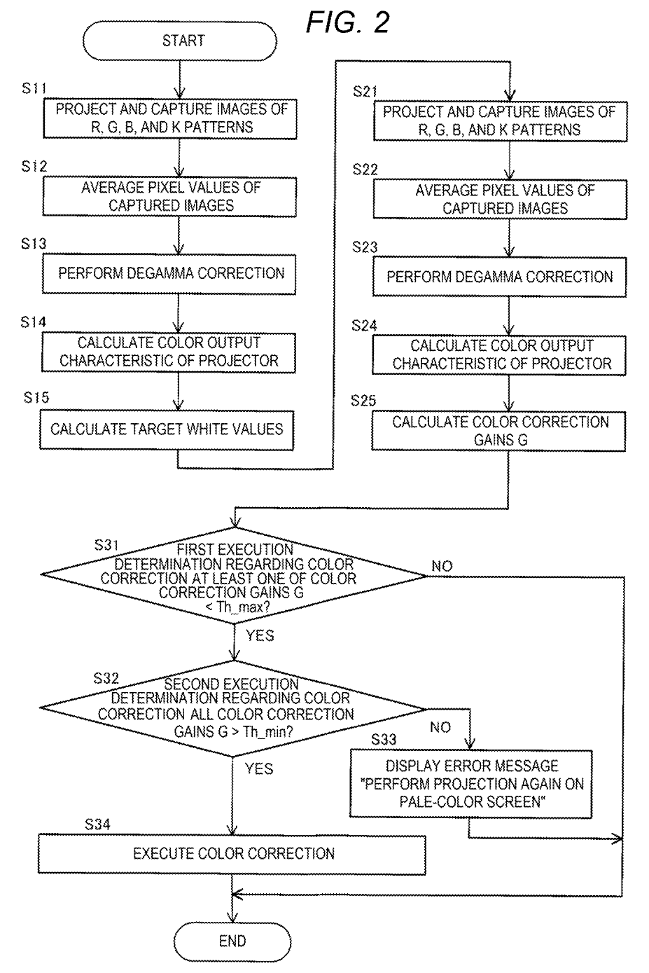

FIG. 2 is a flowchart showing the procedure of an image correction method according to the present embodiment. The correction method is executed by the color correction gain calculation portion 11, which is a function of the computer.

In FIG. 2, steps S11 to S14 are preprocessing performed in the ideal projection environment in which projection is performed onto the projection receiving surface 2 that is a white screen in a dark room. The preprocessing is processing performed before the projection display apparatus 100 is manufactured or shipped. Steps S21 to S25 and S31 to S34 are primary processing performed in the actual projection environment, in which projection is performed at any projection receiving surface 2 such as a wall in any room. Note that the preprocessing may not be performed by the color correction gain calculation portion 11, and that the color conversion matrix in the ideal projection environment may be calculated in advance by another unit and provided to the color correction gain calculation portion 11.

In step S11, the color correction gain calculation portion 11 causes the projector 50 to sequentially project R (Red), G (Green), B (Blue), and K (Black) patterns onto the projection receiving surface 2 (white screen), and causes the camera 30 to capture an image of each of the patterns projected onto the projection receiving surface 2.

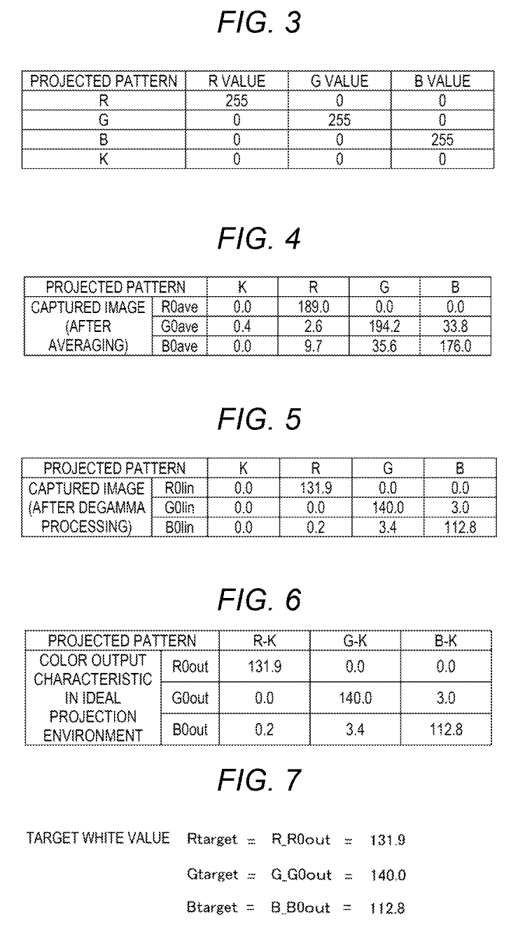

FIG. 3 shows examples of the R, G, B, and K patterns projected in step S11. The R pattern is a pattern in which an R value is 255, a G value is 0, and a B value is 0 at all the first pixels that constitute one pattern. The G pattern is a pattern in which the R value is 0, the G value is 255, and the B value is 0 at all the first pixels that constitute one pattern. The B pattern is a pattern in which the R value is 0, the G value is 0, and the B value is 255 at all the first pixels that constitute one pattern. The K pattern is a pattern in which the R value is 0, the G value is 0, and the B value is 0 at all the first pixels that constitute one pattern.

Next, in step S12, the color correction gain calculation portion 11 averages the pixel values (RGB values) of the multiple second pixels contained in a predetermined range in each of the captured images of the R, G, B, and K patterns captured in step S11. FIG. 4 shows examples of R, G, and B averaged pixel values R0ave, G0ave, and B0ave of the R, G, B, and K captured images produced in step S12.

Next, in step S13, the color correction gain calculation portion 11 performs degamma processing on the averaged pixel values produced in step S12. FIG. 5 shows examples of color pixel values R0lin, G0lin, and B0lin in a linear space, which are produced by the degamma processing. The degamma processing allows the color correction gain calculation portion 11 to acquire a first correspondence relationship, for example, showing that a Y value out of XYZ values as a result of measurement of the R pattern with a spectral radiance meter, that is, the output of the camera 30 linearly changes when the gradation value of each of the multiple second pixels of an image of the R pattern captured by the camera 30, that is, the input of the camera 30 is changed. The same applies to the G pattern and the B pattern. The term "linear" means that a coefficient of the correlation between a change in the input to the camera 30 and a change in an output from the camera 30 is greater than or equal to 0.99. The first correspondence relationship is an example of the input/output characteristics of the camera 30.

Next, in step S14, the color correction gain calculation portion 11 subtracts K pixel values (R0lin, G0lin, B0lin)_K from R pixel values (R0lin, G0lin, B0lin)_R, G pixel values (R0lin, G0lin, B0lin)_G, and B pixel values(R0lin, G0lin, B0lin)_B produced in step S13 to calculate a color output characteristic (R0out, G0out, B0out).

FIG. 6 shows an example of the color output characteristic produced in step S14. The color output characteristic (R0out, G0out, B0out) is a matrix used to convert the pixel values of the multiple first pixels into the pixel values of the multiple second pixels in the ideal projection environment.

Next, in step S15, the color correction gain calculation portion 11 calculates target white values Rtarget, Gtarget, and Btarget from the color output characteristic produced in step S14, as shown in FIG. 7. That is, the color correction gain calculation portion 11 sets diagonal elements R_R0out, G_G0out, and B_B0out in the color output characteristic in FIG. 6 as the target white values Rtarget, Gtarget, and Btarget, respectively. The target white values Rtarget, Gtarget, and Btarget are target pixel values of the second pixels (captured images) used to display a white image at the projection receiving surface 2 in the ideal projection environment.

In the present embodiment, for example, when the gradation value of each of the multiple first pixels of an image of the R pattern projected by the projector 50, that is, the input to the projector 50 is changed, the Y value out of the XYZ values as a result of measurement of the R pattern with a spectral radiance meter, that is, the output from the projector 50 changes linearly after the degamma processing. The term "linear" means that a coefficient of the correlation between a change in the input to the projector 50 and a change in an output from the projector 50 is greater than or equal to 0.99. In the present embodiment, the correspondence relationship between the change in the input to the projector 50 and the change in the output from the projector 50 is referred to as a second correspondence relationship. The second correspondence relationship is an example of the input/output characteristic of the projector 50. The first correspondence relationship is also linear after the degamma processing, as described above. Therefore, in the present embodiment, the input to the camera 30 and the input to the projector 50 change linearly after the degamma processing. Therefore, in steps S11 to S15, the input/output characteristic of the camera 30 and the input/output characteristic of the projector 50 are each a linear characteristic.

The number of patterns can therefore be only four, that is, the R, G, and B patterns, which are patterns for the three primary colors of light, and the K pattern for offsetting the influence of the ambient light.

The color correction gain calculation portion 11 next carries out the processes in steps S21 to S25 and S31 to S34 in the actual projection environment. The actual projection environment is an environment in which a user installs the projection display apparatus 100.

First, in step S21, the color correction gain calculation portion 11 causes the projector 50 to sequentially project the R, G, B, and K patterns onto the projection receiving surface 2, and causes the camera 30 to sequentially capture images of the color patterns sequentially projected onto the projection receiving surface 2, as in step S11.

Next, in step S22, the color correction gain calculation portion 11 averages the pixel values (RGB values) of the multiple second pixels contained in the predetermined range in each of the captured images of the R, G, B, and K patterns captured in step S21, as in step S12. FIG. 8 shows R, G, and B averaged pixel values Rave, Gave, and Bave of the R, G, B, and K captured images produced in step S22.

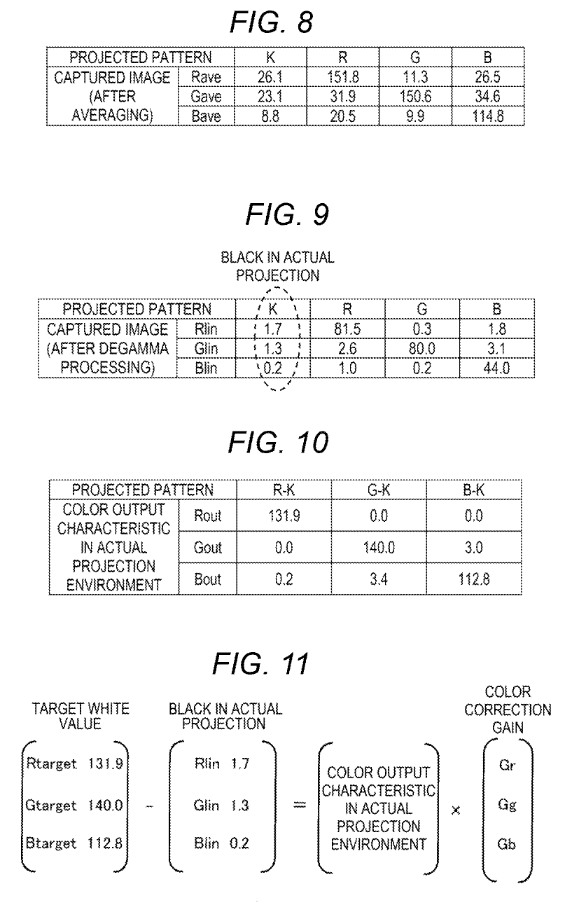

Next, in step S23, the color correction gain calculation portion 11 performs degamma processing on the averaged pixel values produced in step S22, as in step S13. FIG. 9 shows color pixel values Rlin, Glin, and Blin in a linear space, which are produced by the degamma processing.

Next, in step S24, the color correction gain calculation portion 11 subtracts K pixel values (Rlin, Glin, Blin)_K from R pixel values (Rlin, Glin, Blin)_R, G pixel values (Rlin, Glin, Blin)_G, and B pixel values (Rlin, Glin, Blin)_B produced in step S23 to calculate a color output characteristic (Rout, Gout, Bout), as in step S14.

FIG. 10 shows an example of the color output characteristic produced in step S24. The color output characteristic (Rout, Gout, Bout) is a matrix used to convert the pixel values of the multiple first pixels into the pixel values of the multiple second pixels in the actual projection environment.

FIG. 11 illustrates the color correction executed by the color correction portion 12 in the present embodiment. In the color correction, the pixel values (RGB values) of the second pixels of the captured images are multiplied by vectors representing appropriate color correction gains Gr, Gg, and Gb to cause the dynamic range of the pixel values to fall within the range from the black pixel values Rlin, Glin, and Blin (see FIG. 9) in the actual projection environment to the target-white pixel values Rtarget, Gtarget, and Btarget.

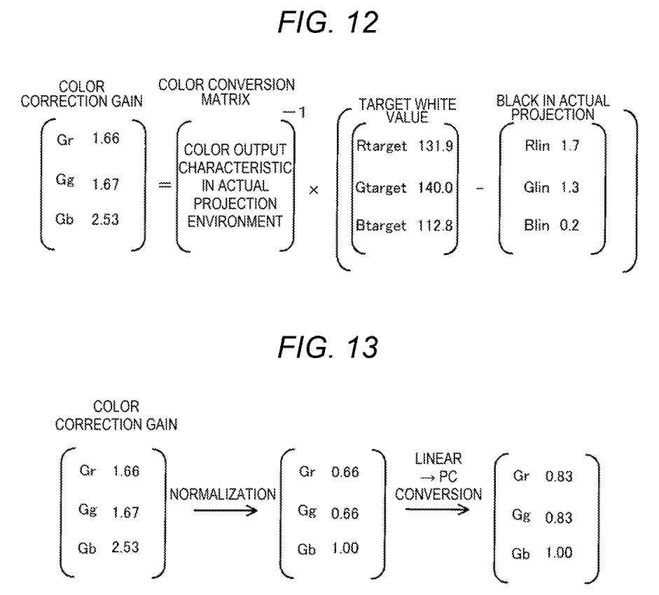

To this end, in step S25, the color correction gain calculation portion 11 determines color vectors by subtracting the pixel values Rlin (1.7 in FIG. 9), Glin (1.3 in FIG. 9), and Blin (0.2 in FIG. 9) of the second pixels at the time of displaying the K pattern in the actual projection environment from the target white values (Rtarget, Gtarget, Btarget), and multiplies the color vectors by the color conversion matrix that is an inverse matrix of the color output characteristic (FIG. 10) in the actual projection environment to calculate the color correction gains Gr (1.66 in FIG. 11), Gg (1.67), and Gb (2.53), as shown in FIG. 12.

Furthermore, the color correction gain calculation portion 11 normalizes the color correction gains Gr, Gg, and Gb calculated in step S25 by using the maximum value thereof, as shown in FIG. 13. In this example, since Gr = 1.66, Gg = 1.67, and Gb = 2.53, the normalization is performed by dividing Gr, Gg, and Gb by the maximum value of 2.53. In addition, the color correction gain calculation portion 11 converts the normalized color correction gains Gr, Gg, and Gb from those in the linear space into those in a PC space used in a camera, a PC, or the like. The color correction gains Gr, Gg, and Gb applicable to the color correction portion 12 are thus produced. In this example, Gr = 0.83, Gg = 0.83, and Gb = 1.0.

Since the camera 30 and the projector 50 used in steps S21 to S25 are the same as the camera 30 and the projector 50 used in steps S11 to S15, the input/output characteristic of the camera 30 and the input/output characteristic of the projector 50 are each a linear characteristic also in steps S21 to S25.

Next, in step S31, the color correction gain calculation portion 11 makes first execution determination regarding the color correction. That is, the color correction gain calculation portion 11 determines whether at least one of the color correction gains Gr, Gg, and Gb is smaller than the maximum threshold Th_max. In the present embodiment, the maximum threshold Th_max is 0.95. When the result of the determination is "YES", the color correction gain calculation portion 11 proceeds to the process in step S32, whereas when the result of the determination is "NO", the color correction gain calculation portion 11 terminates the processes.

Next, having proceeded to step S32, the color correction gain calculation portion 11 makes second execution determination regarding the color correction. That is, the color correction gain calculation portion 11 determines whether the color correction gains Gr, Gg, and Gb are all greater than the minimum threshold Th_min. In the present embodiment, the minimum threshold Th_min is 0.5. When the result of the determination is "YES", the color correction gain calculation portion 11 proceeds to the process in step S34, whereas when the result of the determination is "NO", the color correction gain calculation portion 11 proceeds to the process in step S33.

Next, having proceeded to step S33, the color correction gain calculation portion 11 causes the projector 50 to display, for example, a message "Perform projection again on a pale-color screen" on the projection receiving surface 2. The color correction gain calculation portion 11 then terminates the processes.

When the results of the first execution determination in step S31 and the second execution determination in step S32 are both "YES" and the color correction gain calculation portion 11 proceeds to step S34, the color correction gain calculation portion 11 sets the calculated color correction gains Gr, Gg, and Gb in the color correction portion 12 and causes the color correction portion 12 to execute the color correction. The color correction gain calculation portion 11 then terminates the processes.

As described above, in the present embodiment, when the result of the first execution determination (step S31) is "NO", that is, when none of the color correction gains Gr, Gg, and Gb are smaller than the maximum threshold Th_max, the color correction is not executed. The reason for this is as follows. The fact that none of the color correction gains Gr, Gg, and Gb are smaller than the maximum threshold Th_max means that the color of the wall, which is the projection receiving surface 2, is pale or too light, so that the colors of the captured images are too similar to the target white values. Executing the color correction in this case causes a side effect of deterioration of how well the projection image is colored and hence the image quality, as compared with those before the color correction is executed. This is because a color difference smaller than or equal to a value indicating the performance of the color correction in the projection display apparatus 100 cannot be corrected (the value indicating the performance is, for example, a minimum color difference that can be corrected and is determined by variation in the sensitivity of the camera 30, variation in the intensity of the light projected by the projector 50, the color output characteristics of the camera 30 and the projector 50, and a color correction algorithm). In the present embodiment, to prevent such a side effect, the color correction is not executed when the result of the first determination described above is "NO".

In the present embodiment, when the result of the second execution determination (step S32) is "NO", that is, when at least one of the color correction gains Gr, Gg, and Gb is not greater than the minimum threshold Th_min, the color correction is not executed. The reason for this is as follows. The fact that at least one of the color correction gains Gr, Gg, and Gb is not greater than the minimum threshold Th_min means that the color of the wall, which is the projection receiving surface 2, is too dark, so that the colors of the captured images are too different from the target white values. Executing the color correction in this case causes a side effect of a decrease in the upper limit of the displayable brightness and an excessive decrease in the bright room contrast ratio (for example, 7 or smaller), resulting in deterioration of the image quality. In the present embodiment, to prevent such a side effect, the color correction is not executed when the result of the second determination described above is "NO".

According to the present embodiment, when the results of the first execution determination (step S31) and the second execution determination (step S32) are both "YES", the color correction is executed. The color correction can therefore be executed with none of the side effects such as deterioration of the projection image coloring and hence the image quality due to the colors of the captured images being too similar to the target white values, or deterioration of the image quality due to a decrease in the upper limit of the displayable brightness and an excessive decrease in the bright room contrast ratio (for example, 7 or smaller).

### 2. Variations

The embodiment shown above by way of example can be changed in various manners. Specific aspects of changes applicable to the embodiment described above will be shown below by way of example. Two or more aspects freely selected from the following examples can be combined with each other as appropriate to the extent that no contradiction occurs.

### 2-1. Variation 1

In the embodiment described above, both the first execution determination (step S31) and the second execution determination (step S32) are made, and the color correction is executed when the results of the two types of determination are "YES". However, instead of the above, one of the first execution determination (step S31) and the second execution determination (step S32) may be made, and the color correction may be executed when the result of the determination is "YES".

For example, in a variation 1-1, the color correction gain calculation portion 11 makes only the first execution determination (step S31), executes the color correction when at least one of the color correction gains Gr, Gg, and Gb is smaller than the maximum threshold Th_max, but otherwise does not execute the color correction.

For example, in another variation 1-2, the color correction gain calculation portion 11 makes only the second execution determination (step S32), executes the color correction when the color correction gains Gr, Gg, and Gb are all greater than the minimum threshold Th_min, but otherwise does not execute the color correction and displays, at the projection receiving surface 2, a message prompting the user to change the projection receiving surface 2 to a pale-color projection receiving surface 2.

### 2-2. Variation 2

The user may be allowed to select one of the first execution determination (step S31) and the second execution determination (step S32) to be made.

### 2-3. Variation 3

In the embodiment described above, the first execution determination (step S31) and the second execution determination (step S32) are both made, and when the result of at least one of the two types of determination is "NO", the color correction is not executed. However, instead of the above, the results of the first execution determination (step S31) and the second execution determination (step S32) may be displayed, for example, by the projector 50 to allow the user to select whether to execute the color correction.

### 2-4. Variation 4

The maximum threshold Th_max and the minimum threshold Th_min may be set by the user's operation of any operator.

### 3. Additional remarks

The present disclosure will be summarized below in the form of additional remarks.

(Additional Remark 1) A correction method including: sequentially projecting, via a projector including a light modulating element having multiple first pixels, multiple pattern images onto a projection receiving surface, the multiple pattern images projected via the multiple first pixels having pixel values different from each other; acquiring multiple captured images corresponding on a one-to-one basis to the multiple pattern images by sequentially capturing, with a camera including an imaging element having multiple second pixels, images of the projection receiving surface onto which the multiple pattern images are sequentially projected; generating a color conversion matrix used to convert pixel values of the multiple second pixels into pixel values of the multiple first pixels based on the multiple captured images; calculating, based on the pixel values of the multiple second pixels and the color conversion matrix, color correction gains to be applied to the pixel values of the multiple first pixels to bring colors of the images of the projection receiving surface captured by the camera close to target colors; and executing color correction using the color correction gain for R, the color correction gain for G, and the color correction gain for B when at least one of the color correction gains is smaller than a maximum threshold.

The aspect described above, in which the color correction is executed when the color correction gain for at least one of the colors is smaller than the maximum threshold, can prevent the result of the color correction from deteriorating on the contrary due to the performance of the camera or other factors when the projection receiving surface has a pale color.

(Additional Remark 2) The correction method according to Additional Remark 1, including executing the color correction using the color correction gain for R, the color correction gain for G, and the color correction gain for B when the color correction gains are all greater than a minimum threshold.

The aspect described above, in which the color correction is executed when the color correction gain for R, the color correction gain for G, and the color correction gain for B are all greater than the minimum threshold, can prevent the bright room contrast ratio from deteriorating due to the color correction when the projection receiving surface has a dark color.

(Additional Remark 3) The correction method according to Additional Remark 2, further including displaying a message that recommends changing the projection receiving surface to a pale-color projection receiving surface when at least one of the color correction gain for R, the color correction gain for G, and the color correction gain for B is not greater than the minimum threshold.

According to the aspect described above, the user can readily grasp that the projection receiving surface should be changed to a projection receiving surface that does not cause the bright room contrast ratio to deteriorate.

(Additional Remark 4) The correction method according to any one of Additional Remarks 1 to 3, wherein an input/output characteristic of the projector and an input/output characteristic of the camera are each a linear characteristic, and the color conversion matrix is calculated based on a color output characteristic of the projector measured through projection of R, G, B, and K patterns.

The aspect described above, in which the color correction gains are obtained by projecting the four R, G, B, and K patterns, can shorten the time required to acquire the color correction gains.

(Additional Remark 5) A correction method including: sequentially projecting, via a projector including a light modulating element having multiple first pixels, multiple pattern images onto a projection receiving surface, the multiple pattern images projected via the multiple first pixels having pixel values different from each other; acquiring multiple captured images corresponding on a one-to-one basis to the multiple pattern images by sequentially capturing, with a camera including an imaging element having multiple second pixels, images of the projection receiving surface onto which the multiple pattern images are sequentially projected; generating a color conversion matrix used to convert pixel values of the multiple second pixels into pixel values of the multiple first pixels based on the multiple captured images; calculating, based on the pixel values of the multiple second pixels and the color conversion matrix, color correction gains to be applied to the pixel values of the multiple first pixels to bring colors of the images of the projection receiving surface captured by the camera close to target colors; and executing color correction using the color correction gain for R, the color correction gain for G, and the color correction gain for B when the color correction gains are all greater than a minimum threshold.

The aspect described above, in which the color correction is executed when the color correction gain for R, the color correction gain for G, and the color correction gain for B are all greater than the minimum threshold, can prevent the bright room contrast ratio from deteriorating due to the color correction when the projection receiving surface has a dark color.

(Additional Remark 6) The correction method according to Additional Remark 5, further including displaying a message that recommends changing the projection receiving surface to a pale-color projection receiving surface when at least one of the color correction gain for R, the color correction gain for G, and the color correction gain for B is not greater than the minimum threshold.

According to the aspect described above, the user can readily grasp that the projection receiving surface should be changed to a projection receiving surface that does not cause the bright room contrast ratio to deteriorate.

(Additional Remark 7) The correction method according to Additional Remark 5 or 6, wherein an input/output characteristic of the projector and an input/output characteristic of the camera are each a linear characteristic, and the color conversion matrix is calculated based on a color output characteristic of the projector measured through projection of R, G, B, and K patterns.

The aspect described above, in which the color correction gains are obtained by projecting the four R, G, B, and K patterns, can shorten the time required to acquire the color correction gains.

What is claimed is:

1. An image correction method comprising:
sequentially projecting, via a projector including a light modulating element having multiple first pixels, multiple pattern images onto a projection receiving surface, the multiple pattern images projected via the multiple first pixels having pixel values different from each other;
acquiring multiple captured images corresponding on a one-to-one basis to the multiple pattern images by sequentially capturing, with a camera including an imaging element having multiple second pixels, images of the projection receiving surface onto which the multiple pattern images are sequentially projected;
generating a color conversion matrix used to convert pixel values of the multiple second pixels into pixel values of the multiple first pixels based on the multiple captured images;
calculating, based on the pixel values of the multiple second pixels and the color conversion matrix, color correction gains to be applied to the pixel values of the multiple first pixels to bring colors of the images of the projection receiving surface captured by the camera close to target colors; and
executing color correction using the color correction gain for R, the color correction gain for G, and the color correction gain for B when at least one of the color correction gains is smaller than a maximum threshold.

2. The image correction method according to claim 1, comprising
executing the color correction using the color correction gain for R, the color correction gain for G, and the color correction gain for B when the color correction gains are all greater than a minimum threshold.

3. The image correction method according to claim 2, further including
displaying a message that recommends changing the projection receiving surface to a pale-color projection receiving surface when at least one of the color correction gain for R, the color correction gain for G, and the color correction gain for B is not greater than the minimum threshold.

4. The image correction method according to claim 1, wherein
an input/output characteristic of the projector and an input/output characteristic of the camera are each a linear characteristic, and
the color conversion matrix is calculated based on a color output characteristic of the projector measured through projection of R, G, B, and K patterns.

5. An image correction method comprising:
sequentially projecting, via a projector including a light modulating element having multiple first pixels, multiple pattern images onto a projection receiving surface, the multiple pattern images projected via the multiple first pixels having pixel values different from each other;
acquiring multiple captured images corresponding on a one-to-one basis to the multiple pattern images by sequentially capturing, with a camera including an imaging element having multiple second pixels, images of the projection receiving surface onto which the multiple pattern images are sequentially projected;
generating a color conversion matrix used to convert pixel values of the multiple second pixels into pixel values of the multiple first pixels based on the multiple captured images;
calculating, based on the pixel values of the multiple second pixels and the color conversion matrix, color correction gains to be applied to the pixel values of the multiple first pixels to bring colors of the images of the projection receiving surface captured by the camera close to target colors; and
executing color correction using the color correction gain for R, the color correction gain for G, and the color correction gain for B when the color correction gains are all greater than a minimum threshold.

6. The image correction method according to claim 5, further comprising
displaying a message that recommends changing the projection receiving surface to a pale-color projection receiving surface when at least one of the color correction gain for R, the color correction gain for G, and the color correction gain for B is not greater than the minimum threshold.

7. The image correction method according to claim 5, wherein
an input/output characteristic of the projector and an input/output characteristic of the camera are each a linear characteristic, and
the color conversion matrix is calculated based on a color output characteristic of the projector measured through projection of R, G, B, and K patterns.
